(19) United States
(12) Patent Application Publication
(10) Pub. No.: US 2018/0120136 A1
(43) Pub. Date: May 3, 2018

(54) TIME-VARYING FLOW ESTIMATION FOR VIRTUAL FLOW METERING APPLICATIONS

(71) Applicant: General Electric Company, Schenectady, NY (US)

(72) Inventors: Valentin Thomas, Hennebont (FR); Florent Di Meglio, Paris (FR); Luca Parolini, Munich (DE); Maria Gabriela Gomez, Munich (DE)

(21) Appl. No.: 15/336,337

(22) Filed: Oct. 27, 2016

(51) Int. Cl. G01F 1/34

(52) U.S. Cl. CPC G01F 1/34; G06Q 50/06

(57) ABSTRACT

Virtual flow estimation is described that is suitable for use under steady-state and non-steady-state (i.e., transient) conditions. Examples of such an approach may not perform discretization of the underlying model described by partial differential equations, but may instead perform discretization in a derived estimator separate and distinct from the underlying model. In this manner, a non-executable continuous time-estimator may be transformed to an executable discrete time-estimator suitable for use in under non-steady state (i.e., transient) conditions.

### BACKGROUND

The subject matter disclosed herein relates to the use of virtual flow metering using filtering (e.g., linear filtering) in resource production contexts, such as oil and gas production.

In various contexts where a fluid medium, either liquid or gas, is flowed between various locations, the control of the flow may be controlled at least in part using measured flow aspects. Various types of flow meters may be provided at various states in the flow to provide data on the flow of the fluid at a given time and at a given location. By way of example, in a hydrocarbon production context, flow meters may measure flow at one or more locations in the production path to provide data on the flow of the production fluid through various parts of the production system.

By way of example, two types of flow meter technologies are physical flow meters and virtual flow meters. In the context of physical multiphase flow meters, these flow meters typically estimate the flow rate of each phase in question by utilizing a combination of techniques, which may each in turn utilize various electronic sensing devices, such as microwave sensors, electrical impedance sensors, doppler ultrasound sensors, gamma ray sensors, and so forth.

There may be various drawbacks associated with the use of physical flow meters, including cost (since expensive sensors are typically employed), reliability (since complex sensors are typically more susceptible to failure), communication and power supply issues (e.g., high power consumption to keep sensors working demands specific umbilical pipes), and precision and accuracy (generally, physical flow meters presents high measurement errors due to the complexity of a multiphase flow).

Virtual flow meters may also utilize various sensor systems and algorithms for estimating flow rates. However, virtual flow meters typically make use of less complex types of sensors (e.g. temperature and pressure sensors) from whose measurements flow data is extrapolated. However, real-field estimations often run under steady-state and non-steady-state (transient) conditions and virtual flow meters based on steady state models can only be used under steady-state conditions. Such virtual flow meters are, therefore, are effective only under certain conditions.

### BRIEF DESCRIPTION

In one embodiment, a virtual flow meter is provided that is configured to be used under steady-state and transient condition. In accordance with this approach, the virtual flow meter comprises a controller that is configured to: derive a continuous-time estimator from a model of fluid flow in a fluid transport system; discretize the continuous-time estimator to generate a discrete-time estimator; and execute the discrete-time estimator to implement virtual flow metering on the controller at least under transient conditions.

In a further embodiment, a method is provided for monitoring a fluid gathering network. In accordance with this method, a continuous-time estimator is derived from a model of fluid flow in a fluid transport system. The continuous-time estimator is discretized to generate a discrete-time estimator. The discrete-time estimator is executed to implement virtual flow metering on the controller at least under transient conditions.

In an additional embodiment, one or more computer-readable media comprising executable routines are provided. The routines, when executed by a processor cause acts to be performed comprising: deriving a continuous-time estimator from a model of fluid flow in a fluid transport system; discretizing the continuous-time estimator to generate a discrete-time estimator; and executing the discrete-time estimator to implement virtual flow metering on the controller at least under transient conditions.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a generalized view of a resource production system suitable for use with a virtual flow metering algorithm, in accordance with aspects of the present disclosure;

FIG. 2 depicts a mesh on space time to discretize a partial differential equation;

FIG. 3 depicts divergence of a kernel approximated with a partial differential equation discretized over space where n−100;

FIG. 4 depicts divergence of a kernel approximated with a partial differential equation discretized over space where n−1/h;

FIG. 5 graphically depicts the effects of discretization on the observer as opposed to the differential equation, in accordance with aspects of the present disclosure; and

FIG. 6 depicts the kernel referenced by FIGS. 3-5 and illustrating gain for the observer, in accordance with aspects of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As noted above, real-field estimations often run under steady-state and non-steady-state (transient) conditions. Virtual flow meters based on steady state models can only be used under steady-state conditions and hence, are effective only under certain conditions which are not present at all times. Virtual flow meters based on steady state models are referred to as stationary virtual flow meters herein.

Very few virtual flow meters exist currently which use transient models along with steady state models. These virtual flow meters, to the extent they exist, mitigate the limitation of stationary virtual flow meters by considering transient models also.

Such conventional virtual flow meters employ an initial pre-processing of a transient model through a so called “discretization” step. Such a discretization maps the model, typically described via a set of partial differential equations, into a set of ordinary differential equations that are more readily processed and solved. The drawback of these virtual flow meters is the discretization step, which poses a limit on the overall accuracy of the virtual flow meter and can, under certain cases, render the virtual flow meter unable to correctly estimate the fluid flowing in pipes.

The present described approach eliminates the need for the discretization, instead employing a continuous-time estimator for fluid in pipes. The manner in which the generic estimation problem is mapped on to the partial differential equations so as to allow a continuous-time estimator to be derived is of significance to the present approach and the derivation of the estimator is discussed in greater detail herein. This estimator converges to the true solution under a non-restrictive set of assumptions. Per se, such an estimator cannot be implemented (i.e., is not runnable as an algorithm on a processor or circuit).

Instead, in certain embodiments, after the derivation of the estimator a discretization step is provided. Such a discretization however, is applied to the estimator, not to the original model. In particular, the discretization of the estimator poses no limit on the accuracy of the overall virtual flow meter which is then bounded only by the accuracy of the original model and by the noise superimposed to the measurement. This discretization step transforms the continuous-time estimator, which is not executable on a processor or circuit, into a discrete-time estimator that can be executed as an algorithm on a processor or circuit.

As noted above, the present approach may be employed to estimate flows of a production resource (e.g., a hydrocarbon fluid) in a sub-sea or on-shore production context. In certain contexts, the estimation is performed using virtual flow metering employing time estimation algorithms as discussed herein. In particular, the virtual flow metering discussed herein employs a modeling and estimation approach that allows a virtual flow meter to estimate flow both under steady-state as well as under transient conditions.

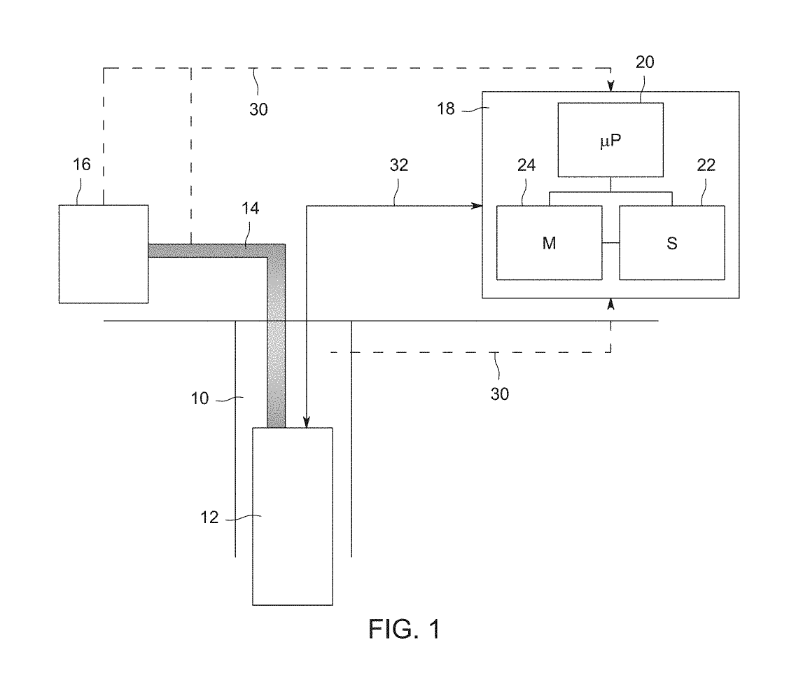

With the preceding in mind, a high-level, simplified overview of aspects of a production site and control system employing a virtual flow meter are shown in FIG. 1. In this example, a hydrocarbon production site is depicted. Such a site may be subsea or on-shore. In this example, the site includes a downhole environment (e.g., a wellbore 10) in which a downhole tool 12 is positioned. The downhole tool 12 may include one or more pumps, such as electric submersible pumps (ESPs), that facilitate the movement of a production fluid 14 from the downhole environment to a downstream facility 16, such as storage tanks, separators or separation tanks, and so forth.

In the depicted example, the flow of the production fluid 14 may be controlled at least in part by the operation of the downhole tool 12 or, in alternative approaches by changing the opening of choke valves located in production manifolds, Xmas trees, a topside separator, or other flow diversion or restriction locations in the production flow path. With reference to the depicted example, the operation of the downhole tool 12 is, in this example, controlled at least in part by the operation of a controller 18 configured to implement a virtual flow meter as discussed herein. Though the downhole tool 12 in this example is depicted as being in communication with, and operated based on, the controller 18, it should be appreciated that other pumps or flow control devices may be operated based on the controller 18 in addition to or instead of the downhole tool 12. For example, the controller 18 (or other similarly configured controllers 18 at the site) may control other devices or components that cause the flow of the production fluid 14 between locations at the monitored site.

In the depicted embodiment, the controller 18 is a processor-based controller, having at least one microprocessor 20 to execute an algorithm corresponding to a virtual flow meter. For example, the microprocessor 20 may execute stored routines corresponding to the virtual flow meter algorithm stored in a storage 22 and/or memory 24 of the controller 18. The processor 20 may also access sensor data 30 acquired from one or more sensor (e.g., pressure and/or temperature sensors, and/or flow rates of gas, oil, and/or water measured using multiphase flow meters) located at locations (as shown by dashed lines 30) in the fluid flow path or via the storage 22 and/or memory. In the same manner, in certain embodiments sensor and/or operational data may be provided to the controller 18 a tool 12 responsible for the flow of the production fluid 14. Though the controller 18 is depicted in FIG. 1 as a stand-alone or specially programmed device, it should be understood that the functionality the controller 18 (e.g., executing routines for implementing a virtual flow meter algorithm) may be one set of routines executed on a computer or other processor-based system that, in addition, executes other routines and performs other functions. Further, though a processor-based implementation is shown in FIG. 1, in alternative implementations the controller 18 may be implemented as one or more application-specific integrated circuits specifically programmed to perform the routines associated with the virtual flow meter described herein when provided with the proper inputs.

In the depicted example, the controller 18 receives sensor input data and acts as virtual flow meter, generating an estimate of the flow of the production fluid 14 at one or more locations in the monitored site. The flow estimates in the depicted example may be used to generate a control signal 32 used to control the operation of one or more flow controlling devices, such as pumps, valves, and so forth. In the depicted example, the control signal 32 is used to control operation of the downhole tool 12, such as an electrical submersible pump or other pumping device. In this manner, based on the flow estimated by the virtual flow meter implemented on controller 18, the operation of one or more flow controlling devices may be controlled so as to stay within desired production parameters.

As discussed herein, the present approach allows the derivation of transient virtual flow meters. Typically, the accuracy of these kinds of virtual flow meters is bounded by the quality and by the size of the discretization step. The described approach removes this limitation and thereby allows the derivation and implementation of more accurate virtual flow meters which can be used at any time in a field.

The following discussion focuses on the case where data from two pressure sensors are available, the inflow comes from a reservoir and the outflow is defined by a valve equation. The following discussion is provided in this context to provide a concrete example and thereby facilitate explanation. It would be recognized by those skilled in the arte that the approach and equations can be generalized and extended to cover other situations where, e.g., multiple pressure sensors are available, or multiple wells are present in the system.

The following paragraphs show how the selected models of each element of the system can be combined in such a way that the overall equation describing the fluid and pressure propagation take the specific form of partial differential equation: they are hyperbolic. Standard known approaches can then be used for deriving for the partial differential equations.

With respect to the notation employed herein:

G refers to the gas phase

L refers to the liquid phase

ν_{I} is the velocity of phase I

α_{I} is the volume fraction of phase I

ρ_{I} is the density of phase I

s or (x) is the space variable

t is the time variable

P is the pressure

A represents the section of the pipe, which may depend on space

W_{I} is the mass flow of phase I such that W_{I}=Aα_{I}ρ_{I}ν_{I}

With respect to the dynamics of the fluid in the present discussion, a biphasic fluid (e.g., gas and liquid) in a pipe is generally described, but the present approach can be extended to multiphasic fluids. With respect to fluid dynamics and mass conservation of the fluids, as considered herein, the mass conservation equations for each phase are the following:

$$\{ \begin{matrix}{\partial }_{t} {α}_{G} {ρ}_{G} + {\partial }_{s} {α}_{G} {v}_{G} = 0 \\ {\partial }_{t} {α}_{L} {ρ}_{L} + {\partial }_{s} {α}_{L} {v}_{L} = 0\end{matrix} \qquad ( 1 )$$

Further, conservation of the total momentum of the fluid may be represented as:

∂ₜ(α_{L}ρ_{L}ν_{L}+α_{G}ρ_{G}ν_{G})+∂ₛ(α_{L}ρ_{L}ν_{L}²+α_{G}ρ_{G}ν_{G}²)+ζₛP=F_{g}+F_{w} (2)

where F_{g} is a term due to gravity and F_{w} is a fluid friction term.

The preceding three equations are insufficient to define the seven present variables (α_{G}, α_{L}, ν_{G}, ν_{L}, ρ_{G}, ρ_{L} and P). Thus, for the present discussion, four additional equations defining relationships among the variables may be based on known closure relations. For example, by definition of the volume fraction:

α_{G}+α_{L}=1 (3)

The slipping law gives a relation between the velocities of the phases:

ν_{G}=C₀(α_{G})(α_{G}ν_{G}+α_{L}ν_{L})+ν_{∞}(α_{G}) (4)

where ν_{∞} and C₀ are empirically known functions.
The density also is a function of the pressure:

$$\begin{matrix}{ρ}_{G} = \frac{P}{{{C}_{G} ( T )}^{2}} & ( 5 ) \\ and & \\ {ρ}_{L} = {ρ}_{L , 0} + \frac{P}{{{C}_{L} ( T )}^{2}} & ( 6 )\end{matrix}$$

In addition, for the present discussion, boundary conditions are imposed on the partial differential equation, such that:

$$\{ \begin{matrix}{{{W}_{G} \vert}_{s = 0} = A {α}_{G} {ρ}_{G} {v}_{G} \vert}_{s = 0} = {W}_{G , i n f ( t )} + max ( 0 , {{k}_{G} ( {P}_{res} - P \vert}_{s = 0} ) ) \\ {{{W}_{L} \vert}_{s = 0} = A {α}_{L} {ρ}_{L} {v}_{L} \vert}_{s = 0} = {W}_{L , i n f ( t )} + max ( 0 , {{k}_{L} ( {P}_{res} - P \vert}_{s = 0} ) \\ {{W}_{G} + {W}_{L} \vert}_{s = L} = {C}_{v} ( z ) \sqrt{\overline{ρ } m} \sqrt{{P \vert}_{s = L} - {P}_{d c}}\end{matrix} \qquad ( 7 )$$

where the top two equations are conditions on the well/pipe interface while the third equation is on the choke/pipe interface.

With the preceding in mind, the fluid dynamics of a fluid transport system considered herein may be simplified as follows. In this example there are three partial differential equations and four closure relationships for seven variables. The problem may be simplified by considering the following conservative state:

q=(α_{G}ρ_{G},α_{L}ρ_{L},α_{G}ρ_{G}ν_{G},α_{L}ρ_{L}ν_{L})^{T} (8)

with the four closure equations (3-6) it is possible to re-write equations (1) and (2) in function of q:

∂ₜq+∂ₛq=G(q). (9)

### Letting A be the Jacobian of f:

$$A ( q ) = ( \frac{\partial {f}_{i}}{\partial {q}_{j}} ) ( q ) \qquad ( 10 )$$

For q̅(s) the equilibrium state, A is diagonalized as:

L(S)A(q̅(s))=Λ(s)L(s) (11)

where Λ(s) is diagonal and its coefficients verify:

λ₁(s)>λ₂(s)>0>λ₃(s) (12)

Then for

w=L(s)δq=L(s)(q−q̅) (13)

the following linear hyperbolic partial differential equation is derived:

∂ₜw+Λ(s)∂ₛw=Σ(s)w (14)

with boundary conditions:

$$\{ \begin{matrix}{w}_{1} ( 0 , t ) = {q}_{1} {w}_{3} ( 0 , t ) \\ {w}_{2} ( 0 , t ) = {q}_{2} {w}_{3} ( 0 , t ) \\ {w}_{3} ( L , t ) = {ρ}_{1} {w}_{1} ( L , t ) + {ρ}_{2} {w}_{2} ( L , t ) + {ρ}_{3} U ( t )\end{matrix} \qquad ( 15 )$$

where w is the state to be estimated.

Discretization of the Estimator—

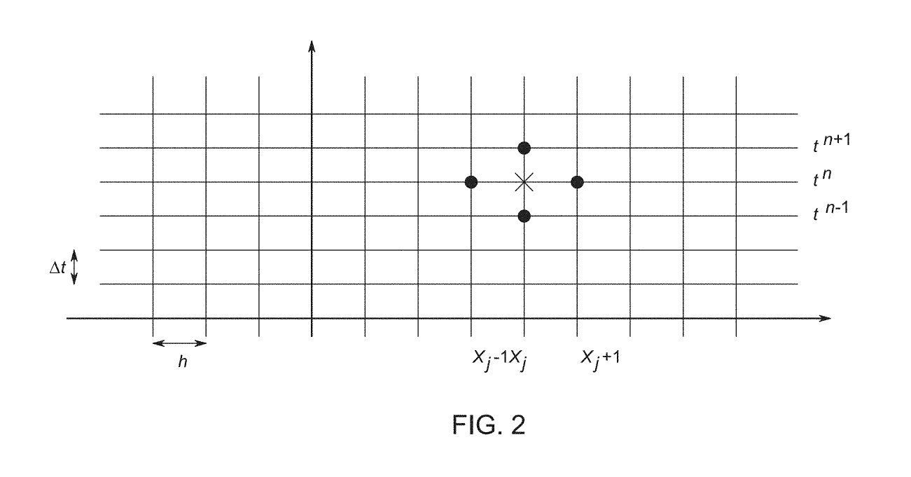

There are several ways to deal with an estimation problem using partial differential equations. For example, solving a partial differential equation can be performed through a discretization over time and space of the equation. For example, FIG. 2 depicts a mesh on space and time to discretize the partial differential equation. As a case in point, to find the values of α(xⱼ, tⁿ) over the grid shown in FIG. 2 the derivatives of w can be expressed as:

$$\{ \begin{matrix}{\partial }_{s} w ( {x}_{j} , {t}^{n} ) ≃ \frac{w ( {x}_{j + 1} , {t}^{n} ) - w ( {x}_{j - 1} , {t}^{n} )}{2 h} \\ {\partial }_{t} w ( {x}_{j} , {t}^{n} ) ≃ \frac{w ( {x}_{j} , {t}^{n + 1} ) - w ( {x}_{j} , {t}^{- 1 n} )}{2 Δ t}\end{matrix} \qquad ( 16 )$$

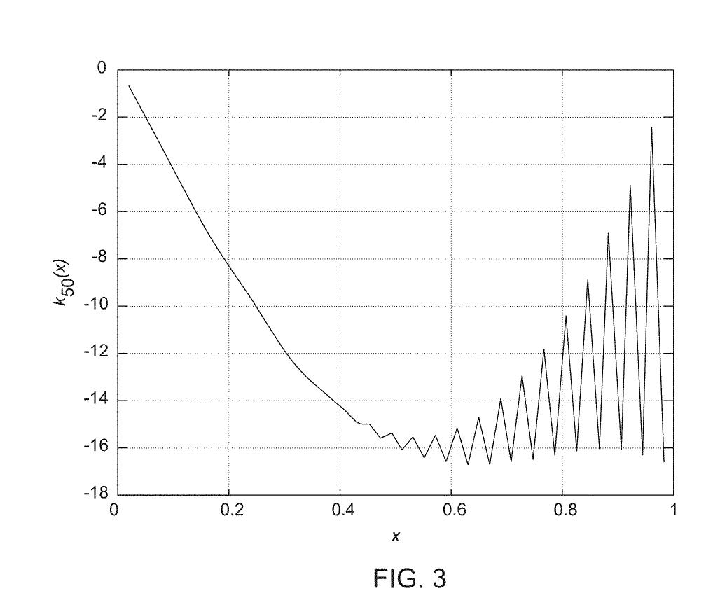

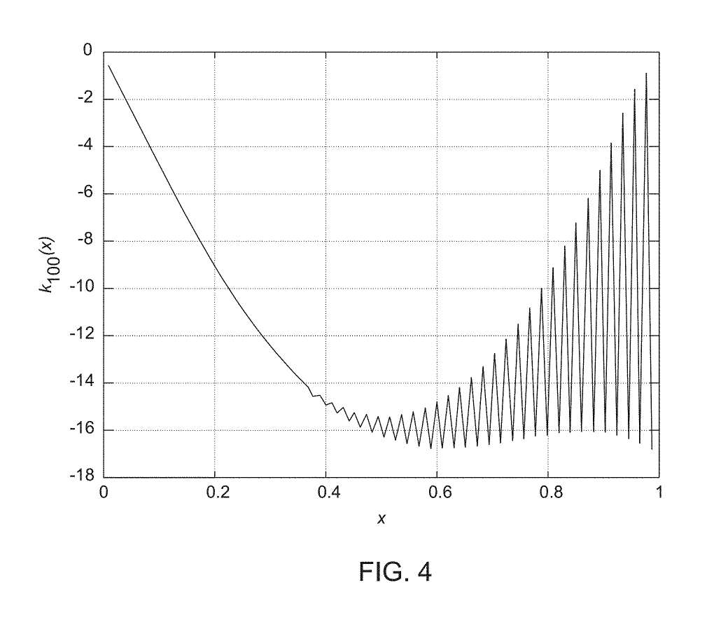

However, in a control context, a different approach may be chosen of discretization over space only, mapping the partial differential equation into a set of ordinary differential equations depending on time. In this manner, it is straightforward to use tools developed for estimation and control as these were historically conceived for ordinary differential equations depending on time. This approach, however, is not suitable for the present discretization context. In particular, h→0 does not ensure that the discretized solution will converge to the continuous real solution. An example of the failure of this approach in the present context is shown in the graphs of FIGS. 3 and 4, where divergence of the kernel approximated with a partial differential equation discretized over space is illustrated. In FIG. 3, n=100; in FIG. 4, n=1/h. As shown, the smaller the step, the stiffer the oscillations.

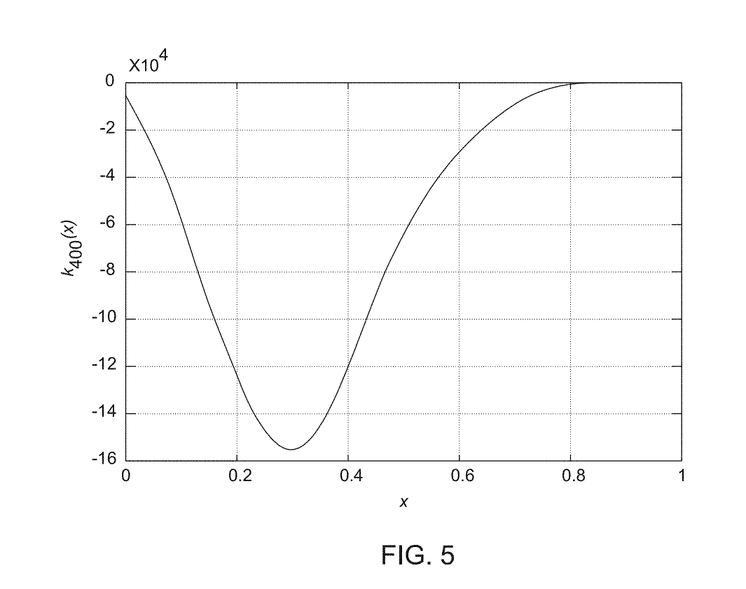

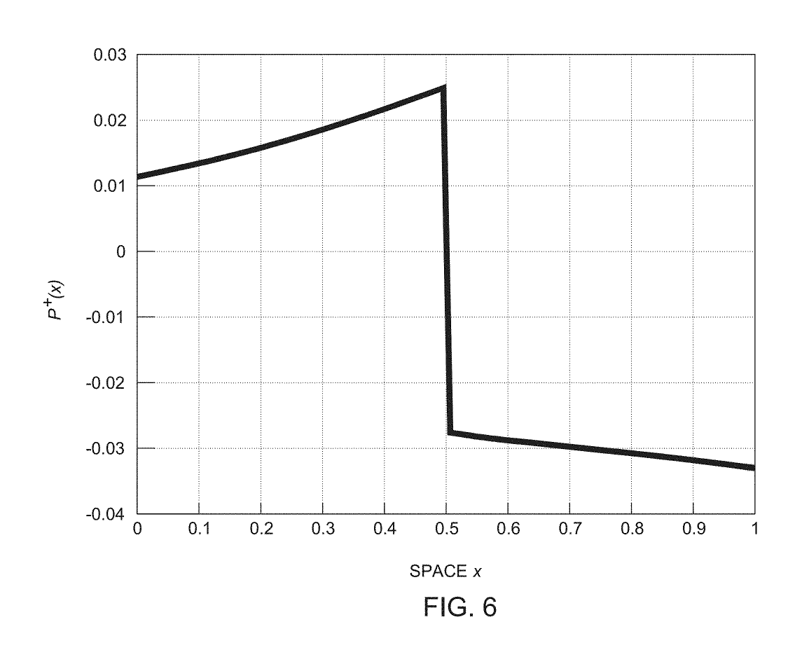

Instead, in accordance with certain embodiments, a different approach is employed in which the continuous observer is discretized instead of the partial differential equation. Unlike the preceding discretization approaches, this approach is stable but needs an explicit analytical form for the observer. With respect to this approach, and turning to FIGS. 5 and 6, the same kernel (shown graphically in FIG. 6) as used is FIGS. 3 and 4 is illustrated, but the discretization was done on the observer and not directly on the partial differential equation. The results are graphically illustrated in FIG. 5, where n=400.

The kernel of the observer employed, illustrated graphically in FIG. 6, depicts gain for the observer. As may be observed, it has a discontinuity that could lead to divergences if we were to discretize the partial differential equation, as evidenced by FIGS. 3 and 4. Thus, trying to approximate discontinuous functions with differentiable ones can also cause errors around the discontinuity points: this is called the Gibbs phenomenon. However, discretizing on the observer, as shown in FIG. 5, prevents such divergence.

With the preceding in mind, for the virtual flow meter time estimation problem, an analytical form for the observer may be employed. As shown, discretizing this analytical observer, rather than the partial differential equation, is more stable and prevents high frequency error phenomenon. This in turn allows the virtual flow meter incorporating and embodying such an approach to estimate flow both under steady-state as well as under transient conditions.

Technical effects of the invention include allowing virtual flow estimation under steady-state and non-steady-state (i.e., transient) conditions using a virtual flow meters that is based on steady state models. Additionally, transient virtual flow meters can be used as “tuner” for existing stationary virtual flow meters.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A virtual flow meter configured to be used under steady-state and transient condition, the virtual flow meter comprising:
a controller configured to:
derive a continuous-time estimator from a model of fluid flow in a fluid transport system;
discretize the continuous-time estimator to generate a discrete-time estimator; and
execute the discrete-time estimator to implement virtual flow metering on the controller at least under transient conditions.

2. The virtual flow meter of claim 1, wherein the controller comprises a processor based-controller.

3. The virtual flow meter of claim 1, wherein the controller comprises an application specific integrated circuit.

4. The virtual flow meter of claim 1, wherein the controller does not discretize the continuous-time estimator by discretizing partial differential equations over time and space.

5. The virtual flow meter of claim 1, wherein the controller does not discretize the continuous-time estimator by discretizing partial differential equations over space only.

6. The virtual flow meter of claim 1, wherein the controller only discretizes the continuous-time estimator and does not discretize a partial differential equation.

7. The virtual flow meter of claim 1, wherein the controller discretizes the continuous-time estimator by discretizing a continuous observer.

8. The virtual flow meter of claim 7, wherein the continuous observer comprises a kernel.

9. The virtual flow meter of claim 8, wherein the kernel corresponds to gain.

10. A method for monitoring a fluid gathering network, comprising:
deriving a continuous-time estimator from a model of fluid flow in a fluid transport system;
discretizing the continuous-time estimator to generate a discrete-time estimator; and
executing the discrete-time estimator to implement virtual flow metering on the controller at least under transient conditions.

11. The method of claim 10, wherein discretizing the continuous-time estimator does not include discretizing partial differential equations over time and space.

12. The method of claim 10, wherein discretizing the continuous-time estimator does not include discretizing partial differential equations over space only.

13. The method of claim 10, wherein discretizing the continuous-time estimator only discretizes the continuous-time estimator and does not discretize a partial differential equation.

14. The method of claim 10, wherein discretizing the continuous-time estimator comprises discretizing a continuous observer.

15. The method of claim 14, wherein the continuous observer comprises a kernel.

16. The method of claim 15, wherein the kernel corresponds to gain.

17. One or more computer-readable media comprising executable routines, which when executed by a processor cause acts to be performed comprising:
deriving a continuous-time estimator from a model of fluid flow in a fluid transport system;
discretizing the continuous-time estimator to generate a discrete-time estimator; and
executing the discrete-time estimator to implement virtual flow metering on the controller at least under transient conditions.

18. The one or more computer-readable media of claim 17, wherein discretizing the continuous-time estimator comprises discretizing a continuous observer.

19. The one or more computer-readable media of claim 18, wherein the continuous observer comprises a kernel.

20. The one or more computer-readable media of claim 19, wherein the kernel corresponds to gain.
